(19) United States
(12) Patent Application Publication
(10) Pub. No.: US 2019/0093675 A1
(43) Pub. Date: Mar. 28, 2019

(54) CENTRIFUGAL COMPRESSOR

(71) Applicant: ATLAS COPCO AIRPOWER, NAAMLOZE VENNOOTSCHAP, Wilrijk (BE)

(72) Inventors: Karel DE KEYSER, Wilrijk (BE); Kristof SUYKERBUYK, Wilrijk (BE)

(73) Assignee: ATLAS COPCO AIRPOWER, NAAMLOZE VENNOOTSCHAP, Wilrijk (BE)

(21) Appl. No.: 16/094,923

(22) PCT Filed: May 4, 2017
(86) PCT No.: PCT/IB2017/000503

§ 371 Date: Oct. 19, 2018

(30) Foreign Application Priority Data
May 6, 2016 (CN) 201620409148.5

(51) Int. Cl. F04D 29/66; F04D 17/10; F04D 29/58; F04D 29/60; F16F 15/08; F16M 1/04

(52) U.S. Cl. CPC F04D 29/668; F04D 17/10; F16M 1/04; F04D 29/601; F16F 15/08; F04D 29/5826

(57) ABSTRACT

A centrifugal compressor includes a compressor head, a motor, a cooler, a support frame, a load-bearing beam and a bottom plate. The cooler and the support frame are fixedly mounted on the bottom plate, the load-bearing beam is arranged above the cooler and the support frame, the support frame supports the load-bearing beam, the compressor head and the motor are arranged above the load-bearing beam, and the compressor head and the motor are fixedly mounted on the load-bearing beam. The centrifugal compressor avoids the problem of triggering resonance, extending the service life of the whole machine.

### TECHNICAL FIELD

The present utility model relates to a centrifugal compressor, especially a centrifugal compressor which can avoid resonance.

### BACKGROUND ART

A centrifugal compressor comprises a compressor head, a motor, a cooler, an oil tank, a chassis and other major components. The compressor head and the motor are the drive chain of the centrifugal compressor rigidly connected to the cooler, the oil tank and the chassis. Only a motor with a fixed power section fits the centrifugal compressor. During operation of the centrifugal compressor, the natural frequency of the complete machine can hardly avoid the section of 50-60 Hz, so that resonance problem is likely to occur. Moreover, after the occurrence of resonance, the natural frequency of the complete machine can hardly be improved by change of the structure, resulting in inextricability of the resonance problem.

Content of the Utility Model

In order to solve the abovementioned problem, the present utility model provides a centrifugal compressor which can avoid resonance during operation thereof.

To realize the above-mentioned object, the centrifugal compressor of the present utility model comprises a compressor head, a motor, a cooler, a support frame, a bearing beam and a chassis. The cooler and the support frame are fixedly mounted on the chassis. The bearing beam is disposed above the cooler and the support frame. The support frame supports the bearing beam. The compressor head, and the motor are disposed above the bearing beam. The compressor head and the motor are fixedly mounted on the bearing beam.

Preferably, a first damping pad is provided between the support frame and the bearing beam. The first damping pad is fixedly connected to the support frame and the bearing beam, respectively.

Preferably, a second damping pad is provided between the cooler and the bearing beam. The second damping pad is fixedly connected to the cooler and the bearing beam, respectively.

Preferably, the second damping pad is fixedly connected to the bearing beam by means of a bearing connector. The bearing connector is welded to the bearing beam. The bearing connector is fixedly connected to the second damping pad by means of a bolt.

Preferably, the centrifugal compressor of the present utility model also comprises an oil tank fixedly mounted on the chassis.

By adding a bearing beam, a first damping pad and a second damping pad, the centrifugal compressor of the present utility model may isolate vibration, prevent vibration of the drive chain from being transmitted onto the chassis, and isolate vibration influence of external vibration on the drive chain at the same time. The centrifugal compressor of the present utility model avoids resonance problem and prolongs the service life of the complete machine.

### BRIEF DESCRIPTION OF THE DRAWINGS

FIG. 1 is a schematic view of the centrifugal compressor of the present utility model;

FIG. 2 is a front view of FIG. 1;

FIG. 3 is a rear view of FIG. 1;

FIG. 4 is a right view of FIG. 1;

### DETAILED DESCRIPTION OF THE EMBODIMENTS

The embodiments of the present utility model are described below in detail with reference to the drawings.

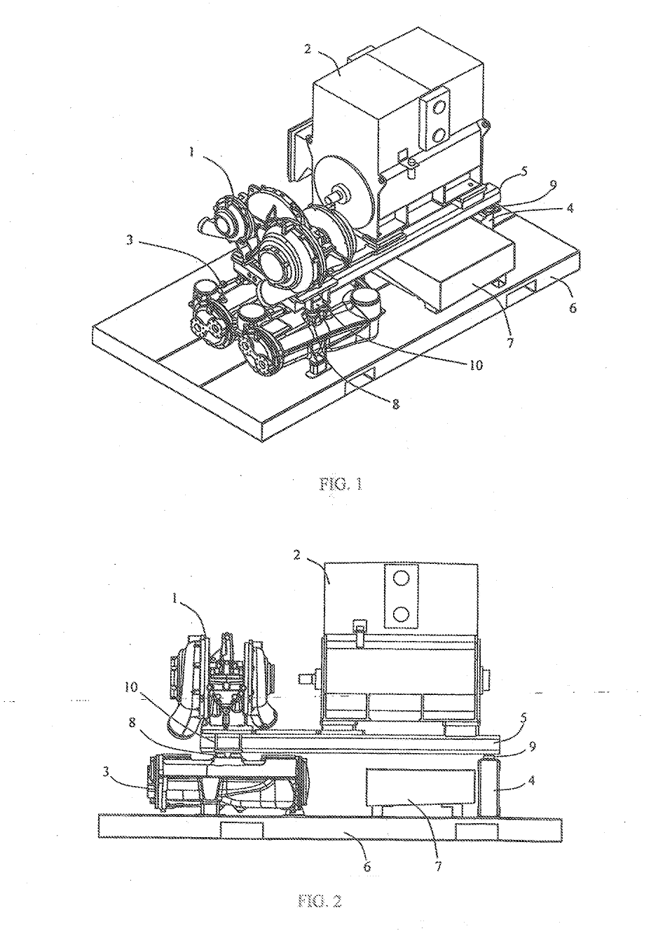

As shown by FIGS. 1-4, the centrifugal compressor of the present utility model comprises a compressor head 1, a motor 2, a cooler 3, a support frame 4, a bearing beam 5 and a chassis 6. The cooler 3 and the support frame 4 are fixedly mounted on the chassis 6. Such fixed mounting may be realized by a bolt. Of course, the support frame 4 may also be fixed on the chassis 6 in a welding manner. The bearing beam 5 is disposed above the cooler 3 and the support frame 4, such that the cooler 3 and the support frame 4 are between the bearing beam 5 and the chassis 6. The bearing beam 5 is supported by the cooler 3 and the support frame 4.

A person skilled in the art can understand that, the bearing beam 5 may also be supported directly by the support frame 4, i.e., the upper portion of the cooler 3 may not be connected with the bearing beam.

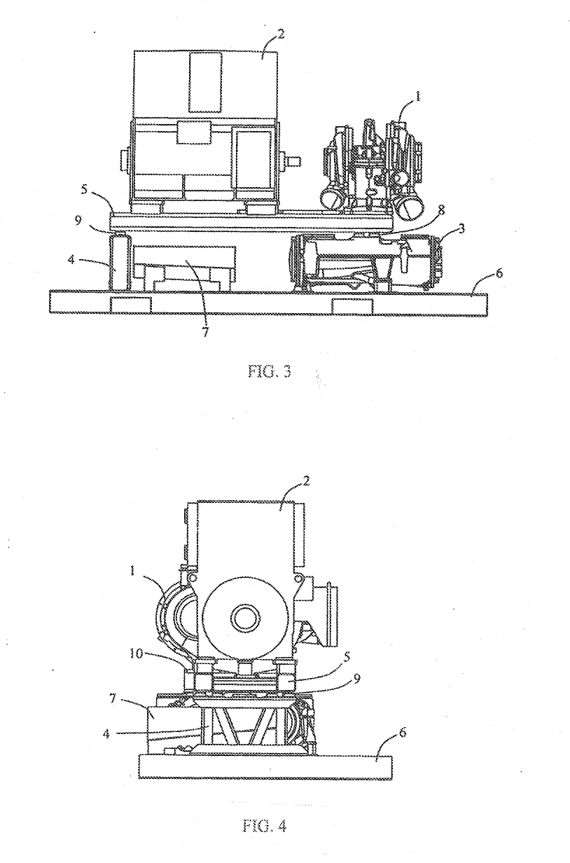

A first damping pad 9 is provided between the support frame 4 and the bearing beam 5. A second damping pad 8 is provided between the cooler 3 and the bearing beam 5. The first damping pad 9 is fixedly connected to the support frame 4 and the bearing beam 5, respectively. The second damping pad 8 is fixedly connected to the cooler 3 and the bearing beam 5, respectively. As shown by FIG. 3, the fixed connection may be realized by a bolt. To facilitate mounting, the second damping pad 8 is preferably fixedly connected to the bearing beam 5 by means of a bearing connector 10, as shown by FIGS. 1 and 2. The bearing connector 10 is welded to the bearing beam 5 and fixedly connected to the second damping pad 8 by means of a bolt.

The first damping pad 9 and the second damping pad 8 may be pressed out of metal wire having damping characteristics, or may also be made from a non-metallic material having damping characteristics, such as rubber, plastic, polyurethane, etc. The number of the first damping pad 9 and the second damping pad may be decided as required.

The compressor head 1 and the motor 2 are disposed above the bearing beam 5. The compressor head 1 and the motor 2 are fixedly mounted on the bearing beam 5, and the fixed mounting may be realized by a bolt.

By adding a bearing beam 5 and providing a second damping pad 8 and a first damping pad 9 between the cooler 3, the support frame 4 and the bearing beam 5, the centrifugal compressor of the present utility model may isolate vibration, prevent vibration of the drive chain (i.e., the compressor head 1 and the motor 2) from being transmitted onto the chassis 6, and isolate vibration influence of external vibration on the drive chain at the same time. Use of the above structure avoids resonance problem and a motor with a broader power section is adapted. Moreover, it is ensured that the natural frequency of the complete machine avoids the section of 50-60 Hz.

The centrifugal compressor of the present utility model also comprises an oil tank 7 fixedly mounted on the chassis 6. As introduction of the bearing beam 5 separates the oil tank 7 which is no long used as a bearing member, the design of the oil tank is simplified.

As described above, the exemplary embodiments of the present utility model have been described in detail with reference to the drawings. It should be understood that, the present utility model is not intended to constitute restrictions to the protection scope thereof with these details. Equivalent or similar modifications may be made to the structures and features of the exemplary embodiments without departing from the spirit and scope of the present utility model, and these modifications shall be included within the protection scope determined by the claims of the present utility model.

1.-4. (canceled)

5. A centrifugal compressor, which comprises a compressor head, a motor, a cooler, a support frame, a bearing beam and a chassis;
the cooler and the support frame are fixedly mounted on the chassis;
the bearing beam is disposed above the cooler and the support frame, the support frame supports the bearing beam;
the compressor head and the motor are disposed above the bearing beam and fixedly mounted on the bearing beam, wherein a first damping pad is provided between the support frame and the bearing beam, the first damping pad being fixedly connected to the support frame and the bearing beam, respectively.

6. The centrifugal compressor according to claim 5, wherein a second damping pad is provided between the cooler and the bearing beam, the second damping pad being fixedly connected to the cooler and the bearing beam, respectively.

7. The centrifugal compressor according to claim 6, wherein the second damping pad is fixedly connected to the bearing beam by means of a bearing connector welded to the bearing beam and fixedly connected to the second damping pad by means of a bolt.

8. The centrifugal compressor according to claim 5, further comprising an oil tank fixedly mounted on the chassis.

9. A centrifugal compressor comprising a compressor head, a motor, a cooler, a support frame, a bearing beam, a chassis, a first damping pad, and a second damping pad;
wherein the cooler and the support frame are fixedly mounted on the chassis, the bearing beam is disposed above the cooler and the support frame, the support frame supports the bearing beam, the compressor head and the motor are disposed above the bearing beam, the compressor head and the motor are fixedly mounted on the bearing beam, the first damping pad is between the support frame and the bearing beam, the first damping pad is fixedly connected to the support frame and the bearing beam, the second damping pad is between the cooler and the bearing beam, and the second damping pad is fixedly connected to the cooler and the bearing beam.
